(19) United States
(12) Patent Application Publication
(10) Pub. No.: US 2023/0218473 A1
(43) Pub. Date: Jul. 13, 2023

(54) MASSAGING FOOTWEAR

(71) Applicant: Walkiris Gregorio Santos, Slatington, PA (US)

(72) Inventor: Walkiris Gregorio Santos, Slatington, PA (US)

(21) Appl. No.: 17/574,345

(22) Filed: Jan. 12, 2022

(51) Int. Cl. A61H 15/00

(52) U.S. Cl. CPC A61H 15/0078; A61H 2015/005; A61H 2201/1654; A61H 2201/165; A61H 2201/123; A61H 2205/12; A61H 2201/164

(57) ABSTRACT

A massaging footwear, including a main body, including an upper section to cover at least a top portion of the foot, and a sole section disposed on at least a portion of the upper section to receive at least a portion of the foot thereon, a plurality of massaging spheres disposed within at least a portion of the sole section, and a motor disposed within at least a portion of the sole section to move the plurality of massaging spheres in response to movement of the motor.

### BACKGROUND

### 1. Field

The present general inventive concept relates generally to footwear, and particularly, to massaging footwear.

### 2. Description of the Related Art

Footwear come in a variety of types, shapes, and/or sizes. Regardless, modern footwear serve a purpose of protecting a foot of a person from potential injury while moving in an environment. However, most footwear do not provide any relief for people who must stand while working long hours and/or must walk over long distances. This can make the footwear uncomfortable.

In most cases, the person will have to rest by sitting and/or laying down to ease pressure on the feet. Additionally, the person can rub the feet to provide relief to any built-up tension.

Therefore, there is a need for massaging footwear to provide relief for pain and/or relaxation to the feet of the person.

### SUMMARY

The present general inventive concept provides massaging footwear.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a massaging footwear, including a main body, including an upper section to cover at least a top portion of the foot, and a sole section disposed on at least a portion of the upper section to receive at least a portion of the foot thereon, a plurality of massaging spheres disposed within at least a portion of the sole section, and a motor disposed within at least a portion of the sole section to move the plurality of massaging spheres in response to movement of the motor.

The main body may further include a gel liner disposed on at least a portion of the sole section to absorb an impact thereon in response to an application of force.

The motor may span an entirety of the sole section.

The motor may laterally move from a first end of the sole section to at least partially toward a second end of the sole section, and from the second end of the sole section to at least partially toward the first end of the sole section.

The motor may include a plurality of pistons that alternate in an upward and downward motion with respect to a base of the main body.

The motor may laterally move from a first end of the sole section to at least partially toward a second end of the sole section, and from the second end of the sole section to at least partially toward the first end of the sole section, such that the plurality of massaging spheres move in a wave.

The massaging footwear may further include a power button disposed on at least a portion of the sole section to activate or deactivate in response to tapping heels together.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a sectional elevational side view of massaging footwear, according to an exemplary embodiment of the present general inventive concept; and

FIG. 2 illustrates a sectional view of the massaging footwear, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Massaging Footwear 100
Main Body 110
Upper Section 111
Sole Section 112
Gel Liner 113
Massaging Spheres 120
Motor 130
Power Button 140
Power Source 150
Charging Port 160

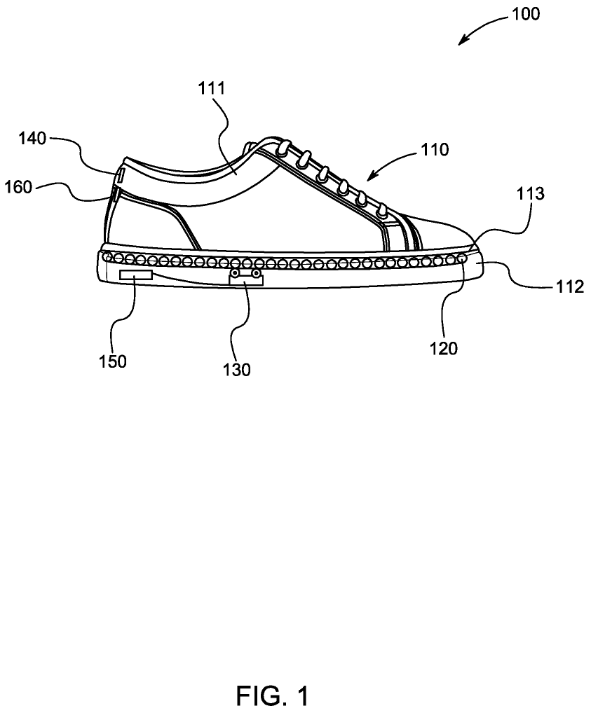

FIG. 1 illustrates a sectional elevational side view of massaging footwear 100, according to an exemplary embodiment of the present general inventive concept.

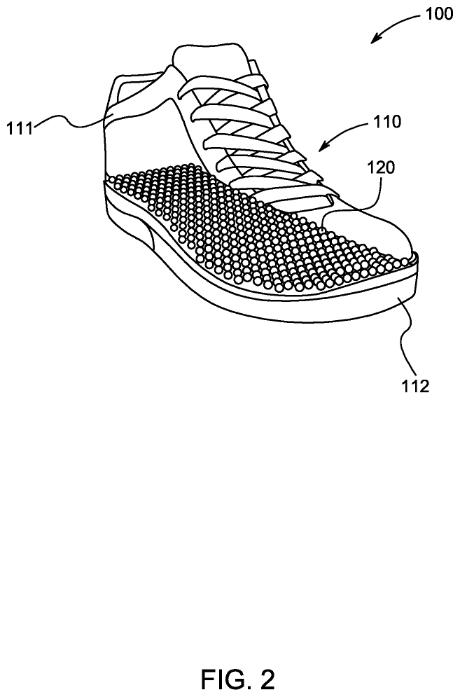

FIG. 2 illustrates a sectional view of the massaging footwear 100, according to an exemplary embodiment of the present general inventive concept.

The massaging footwear 100 may be constructed from at least one of metal, plastic, wood, and rubber, etc., but is not limited thereto.

The massaging footwear 100 may include a main body 110, a plurality of massaging spheres 120, a motor 130, a power button 140, a power source 150, and a charging port 160, but is not limited thereto.

Referring to FIGS. 1 and 2, the main body 110 is illustrated to be a sneaker. However, the main body 110 may be a boot, a sandal, a slipper, a sock, or any other type of footwear known to one of ordinary skill in the art, but is not limited thereto.

The main body 110 may include an upper section 111, a sole section 112, and a gel liner 113, but is not limited thereto.

The upper section 111 may cover at least a top portion of a foot of a user. Moreover, the upper section 111 may extend from a base of the foot toward a heel (e.g., sneakers) and/or a knee (e.g., boots). The upper section 111 may be ventilated (e.g., have a plurality of holes) and/or be solid construction that lacks any ventilation, such that a liquid may not leak into an interior of the upper section 111.

Also, an inner surface of a toe section of the upper section 111 may have a steel frame connected thereto. In other words, the upper section 111 may have a steel toe. Accordingly, the toe section of the upper section 111 may prevent injury to toes of the user in response to an impact by an external object.

The sole section 112 may be disposed on at least a portion of the upper section 111. The sole section 112 may form a base of the main body 110 and receive at least a portion of a base of the foot thereon. In other words, the sole section 112 may support the foot thereon.

The gel liner 113 may include a gel, a plurality of air bubbled protrusions, and a foam, but is not limited thereto.

The gel liner 113 may be disposed on at least a portion of the sole section 112. The gel liner 113 may absorb an impact thereon in response to an application of force, such as during walking and/or running by the user. As such, the gel liner 113 may protect the foot in response to striking the sole section 112.

Each of the plurality of massaging spheres 120 may have a spherical shape. Additionally, the plurality of massaging spheres 120 may be disposed within at least a portion of the sole section 112 and/or connected to the gel liner 113. Accordingly, the plurality of massaging spheres 120 may create a bumpy sensation in response to contacting the gel liner 113 with the foot.

The motor 130 may be disposed within at least a portion of the sole section 112. Referring again to FIG. 1, the motor 130 is illustrated to be cover a section of the sole section 112. However, the motor 130 may span an entirety of the sole section 112. The motor 130 may include a plurality of pistons, such that the plurality of massaging spheres 120 may move in response to movement of the plurality of pistons of the motor 130. More specifically, each of the plurality of pistons of the motor 130 may alternate in an up and/or down motion (e.g., toward and/or away from the gel liner 113, a base of the main body 110), either independently and/or simultaneously with respect to each other. As such, the plurality of massaging spheres 120 may provide a pressured sensation to the foot (e.g., a massage) in response to movement of the motor 130.

Alternatively, the motor 130 may be movably (i.e., slidably, rollably) disposed within at least a portion of the sole section 112. In other words, the motor 130 may laterally move (e.g., roll) from a first end of the sole section 112 to at least partially toward a second end of the sole section 112, and from the second end of the sole section 112 to at least partially toward the first end of the sole section 112. During the movement, the motor 130 may intermittently project the plurality of pistons toward the plurality of massaging spheres 120 to create the pressured sensation on the foot. It is important to note that an operation of the motor 130 in the rolling configuration differs from the previous due to the motor 130 actually changing position within the sole section 112. Therefore, the motor 130 in the rolling configuration creates a rolling effect of pressure from the plurality of massaging spheres 120 similar to a wave in water.

Referring again to FIG. 1, the power button 140 is illustrated to be disposed on a rear portion of the upper section 111. However, the power button 140 may be disposed on at least a portion of the sole section 112, such a rear of the sole section 112. The power button 140 may turn on the motor 130 in response to depressing the power button 140 a first time. Subsequently, the power button 140 may turn off the motor 130 in response to depressing the power button 140 a second time different from the first time. Furthermore, the power button 140 may set a first speed level of the motor 130 in response to depressing the power button 140 for a first predetermined period of time (e.g., two seconds, five seconds). Also, the power button 140 may set a second speed level of the motor 130 in response to depressing the power button 140 for a second predetermined period of time (e.g., ten seconds, fifteen seconds). The second speed level may be greater than the first speed level, such that the second speed level may provide a faster and/or more intense massage.

Also, in a situation where the power button 140 is disposed on the sole section 112, the power button 140 may be activated and/or deactivated by tapping heels of the main body 110 together (e.g., when wearing a pair of the footwear).

The power source 150 may include a battery and a solar cell, but is not limited thereto.

The power source 150 may be disposed within at least a portion of the sole section 112 and/or connected to the motor 130 and/or the power button 140. The power source 150 may send power to the motor 130 and/or the power button 140.

The charging port 160 may be disposed on at least a portion of the upper section 111 and/or connected to the power source 150. The charging port 160 may receive an external connection therein, such as a power cord connected to a power outlet. Thus, the charging port 160 may receive power from the external connection to recharge the power source 150.

Therefore, the massaging footwear 100 may provide pain relief to the foot of the user by massaging the foot. Also, the massaging footwear 100 may prevent injury to the foot during use.

The present general inventive concept may include a massaging footwear 100, including a main body 110, including an upper section 111 to cover at least a top portion of the foot, and a sole section 112 disposed on at least a portion of the upper section 111 to receive at least a portion of the foot thereon, a plurality of massaging spheres 120 disposed within at least a portion of the sole section 112, and a motor 130 disposed within at least a portion of the sole section 112 to move the plurality of massaging spheres 120 in response to movement of the motor 130.

The main body 110 may further include a gel liner 113 disposed on at least a portion of the sole section 112 to absorb an impact thereon in response to an application of force.

The motor 130 may span an entirety of the sole section 112.

The motor 130 may laterally move from a first end of the sole section 112 to at least partially toward a second end of the sole section 112, and from the second end of the sole section 112 to at least partially toward the first end of the sole section 112.

The motor 130 may include a plurality of pistons that alternate in an upward and downward motion with respect to a base of the main body 110.

The motor 130 may laterally move from a first end of the sole section 112 to at least partially toward a second end of the sole section 112, and from the second end of the sole section 112 to at least partially toward the first end of the sole section 112, such that the plurality of massaging spheres 120 move in a wave.

The massaging footwear 100 may further include a power button 140 disposed on at least a portion of the sole section 112 to activate or deactivate in response to tapping heels together.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A massaging footwear, comprising:
a main body, comprising:
an upper section to cover at least a top portion of the foot, and
a sole section disposed on at least a portion of the upper section to receive at least a portion of the foot thereon;
a plurality of massaging spheres disposed within at least a portion of the sole section; and
a motor disposed within at least a portion of the sole section to move the plurality of massaging spheres in response to movement of the motor.

2. The massaging footwear of claim 1, wherein the main body further comprises:
a gel liner disposed on at least a portion of the sole section to absorb an impact thereon in response to an application of force.

3. The massaging footwear of claim 1, wherein the motor spans an entirety of the sole section.

4. The massaging footwear of claim 1, wherein the motor laterally moves from a first end of the sole section to at least partially toward a second end of the sole section, and from the second end of the sole section to at least partially toward the first end of the sole section.

5. The massaging footwear of claim 1, wherein the motor includes a plurality of pistons that alternate in an upward and downward motion with respect to a base of the main body.

6. The massaging footwear of claim 1, wherein the motor laterally moves from a first end of the sole section to at least partially toward a second end of the sole section, and from the second end of the sole section to at least partially toward the first end of the sole section, such that the plurality of massaging spheres move in a wave.

7. The massaging footwear of claim 1, further comprising:
a power button disposed on at least a portion of the sole section to activate or deactivate in response to tapping heels together.
